(19) United States
(12) Patent Application Publication
(10) Pub. No.: US 2024/0145135 A1
(43) Pub. Date: May 2, 2024

(54) METHOD FOR PRODUCING A RAW MAGNET

(71) Applicant: MIMPLUS TECHNOLOGIES GMBH & CO. KG, Ispringen (DE)

(72) Inventors: Johannes MAURATH, Ettlingen (DE); Simone SCHUSTER, Renningen (DE)

(21) Appl. No.: 18/276,106

(22) PCT Filed: Dec. 22, 2021
(86) PCT No.: PCT/EP2021/087411

§ 371 Date: Aug. 7, 2023

(30) Foreign Application Priority Data
Feb. 15, 2021 (DE) 10 2021 201 413.5

(51) Int. Cl. H01F 1/055; H01F 1/053; H01F 1/057; H01F 41/02

(52) U.S. Cl. CPC H01F 1/0551; H01F 1/0536; H01F 1/0557; H01F 1/0577; H01F 41/0266

(57) ABSTRACT

A method for manufacturing a raw magnet includes manufacturing a first raw form from a first magnetic base material; manufacturing a second raw form from a second magnetic base material; and applying an external magnetic field to at least one raw form selected from a group consisting of the first raw form and the second raw form during and/or after manufacturing of the raw form. A third raw form is manufactured from the first raw form and the second raw form by joining them together. The third raw form is sintered and the raw magnet is obtained.

The invention relates to a method for manufacturing a raw magnet.

Permanent magnets from the rare earth group are used in a variety of technical applications and are characterised by a particularly high energy product. Neodymium-iron-boron magnets in particular comprise an energy product of up to 400 kJ/m 3.

Known methods for manufacturing a permanent magnet include the production, in particular the pressing, of a raw form and the subsequent sintering of the raw form. The disadvantage of these methods is that only simple magnet shapes, in particular cylinders or cuboids, and/or simple magnetisations, in particular an axial magnetisation, can be realised. A magnet shape and/or magnetisation adapted to a special requirement is therefore not possible.

For the realisation of complex magnet shapes and/or complex magnetisations, methods are known in which at least two magnetised magnets are connected to each other. The disadvantage of this is that these methods are very complicated and time-consuming due to the mutual attraction of the magnets. Furthermore, the magnets can be damaged and a worker can be injured, especially in the form of bruising, if the magnets collide uncontrollably due to their mutual attraction.

Furthermore, mechanical fixation of a magnet comprising at least one rare earth element in an assembly is not possible. The reasons for this include the simple shape of the magnet and the fact that threads and bores cannot be manufactured by means of press sintering. Likewise, machining the magnet is difficult because it is extremely brittle and should be avoided with the aim of efficient raw material utilisation.

Methods are known for fixing magnets, in particular in an assembly, in which the magnets are glued into the assembly or are doused or overmolded with an impregnating resin. The disadvantage of this is that the assembly is very time-consuming and that the gluing and/or the impregnating resin can cause corrosion of the magnet.

The invention is therefore based on the problem of providing a method for manufacturing a raw magnet, in particular for manufacturing a permanent magnet, wherein the disadvantages mentioned, in particular with regard to the permanent magnet to be ultimately manufactured, are at least partially eliminated, preferably avoided.

The problem is solved by providing the present technical teaching, in particular the teaching of the independent claims as well as the embodiments disclosed in the dependent claims and the description.

In particular, the problem is solved by providing a method for manufacturing a raw magnet, wherein a first raw form is manufactured from a first magnetic base material and a second raw form is manufactured from a second magnetic base material. Furthermore, an external magnetic field is applied to at least one raw form selected from a group consisting of the first raw form and the second raw form during manufacturing of the raw form. Alternatively or additionally, an external magnetic field is applied to the at least one raw form after manufacturing of the raw form. Subsequently, a third raw form is manufactured from the first raw form and the second raw form by joining them together. The third raw form is sintered, wherein the raw magnet is obtained.

Advantageously, the method is suitable for manufacturing permanent magnets, which are obtained after magnetising the raw magnets, with a complex magnet shape and/or a complex magnetisation. The produced permanent magnet preferably comprises a magnet shape and/or magnetisation which can be adapted to a special requirement. Furthermore, little or no post-processing of the raw magnet is required. Furthermore, during sintering of the third raw form, a substance-to-substance bonding is advantageously produced between the first raw form and the second raw form.

Advantageously, dipoles of the magnetic base material are aligned in a parallel orientation by means of the externally applied magnetic field during manufacturing and/or after manufacturing of the at least one raw form.

Preferably, the externally applied magnetic field is generated by a switchable electromagnet and/or a permanent magnet.

In an embodiment, the third raw form is formed from a plurality of raw forms, in particular a plurality of first raw forms and/or a plurality of second raw forms.

In an embodiment, the at least one raw form, in particular exactly one raw form selected from a group consisting of the first raw form and the second raw form, is manufactured in the externally applied magnetic field. Advantageously, the particles of the magnetic base material from which the at least one raw form is manufactured align themselves according to the externally applied magnetic field while the at least one raw form is being manufactured. Preferably, the magnetic base material of the at least one raw form, in particular of the exactly one raw form, is hard magnetic. In particular, the external magnetic field is applied to the at least one raw form, in particular the exactly one raw form, only during the manufacturing of the at least one raw form, in particular the exactly one raw form. In particular, the external magnetic field is not applied to the at least one raw form, in particular the exactly one raw form, after the manufacturing of the at least one raw form, in particular the exactly one raw form.

In a further embodiment, the external magnetic field is applied to the at least one raw form, in particular to exactly one raw form selected from a group consisting of the first raw form and the second raw form, after manufacturing of the at least one raw form, in particular of the exactly one raw form. In particular, the external magnetic field is applied to the at least one raw form, in particular the exactly one raw form, only after the manufacturing of the at least one raw form, in particular the exactly one raw form. In particular, the external magnetic field is not applied to the at least one raw form, in particular the exactly one raw form, during the manufacturing of the at least one raw form, in particular the exactly one raw form.

In a further embodiment, the external magnetic field is applied to the at least one raw form, in particular to exactly one raw form selected from a group consisting of the first raw form and the second raw form, during and after manufacturing of the raw form, in particular of the exactly one raw form.

In a further embodiment, the first raw form and the second raw form are manufactured in the externally applied magnetic field. In particular, the external magnetic field is applied to the first raw form only during the manufacturing of the first raw form. In addition, the external magnetic field is in particular applied to the second raw form only during the manufacturing of the second raw form. In particular, the external magnetic field is not applied to the first raw form after the manufacturing of the first raw form. In addition, the external magnetic field is in particular not applied to the second raw form after the manufacturing of the second raw form.

In a further embodiment, the external magnetic field is applied to the first raw form and the second raw form after the manufacturing of the first raw form and the second raw form. In particular, the external magnetic field is applied to the first raw form only after the manufacturing of the first raw form. In addition, the external magnetic field is in particular applied to the second raw form only after manufacturing of the second raw form. In particular, the external magnetic field is not applied to the first raw form during the manufacturing of the first raw form. In addition, the external magnetic field is in particular not applied to the second raw form during the manufacturing of the second raw form.

In a further embodiment, the first raw form is manufactured in the externally applied magnetic field. In addition, the external magnetic field is applied to the second raw form after manufacturing of the second raw form. In particular, the external magnetic field is applied to the first raw form only during the manufacturing of the first raw form. In particular, the external magnetic field is not applied to the first raw form after the manufacturing of the first raw form. Additionally, in particular, the external magnetic field is applied to the second raw form only after the manufacturing of the second raw form. In particular, the external magnetic field is not applied to the second raw form during the manufacturing of the second raw form.

In a further embodiment, the second raw form is manufactured in the externally applied magnetic field. Additionally, the external magnetic field is applied to the first raw form after manufacturing the first raw form. In particular, the external magnetic field is applied to the second raw form only during the manufacturing of the second raw form. In particular, the external magnetic field is not applied to the second raw form after the manufacturing of the second raw form. Additionally, in particular, the external magnetic field is applied to the first raw form only after the manufacturing of the first raw form. In particular, the external magnetic field is not applied to the first raw form during the manufacturing of the first raw form.

In a further embodiment, the external magnetic field is applied to the first raw form during and after manufacturing of the first raw form. Additionally, the external magnetic field is applied to the second raw form during and after the manufacturing of the second raw form. Additionally, particularly preferably, the second raw form is heated to the softening temperature while the external magnetic field is applied.

Advantageously, the method is suitable for powdered magnetic starting materials which are formed on the basis of a newly melted alloy, in particular in the form of a cast ingot or in the form of melt-spun material. Alternatively or additionally, the method is suitable for recycled magnetic material and/or contaminated recycled magnetic material. In addition, material obtained by recycling is preferably alloyed with at least one rare earth element, preferably in powdered form, to improve its properties.

The first magnetic base material and/or the second magnetic base material are preferably in a pure form or in a hydrogenated form. The US patent application US 2013/0263699 A1 and the German patent DE 198 43 883 C1 describe a method, called hydrogen decrepitation (HD), for manufacturing a hydrogenated form of the first magnetic base material and/or the second magnetic base material by means of a hydrogen-induced decay.

Preferably, a magnetic primary material is mechanically reduced, in particular by grinding, to a particle size of at least 1 μm to at most 200 μm to obtain a powdered magnetic base material selected from the first magnetic base material and the second magnetic base material.

Preferably, the first magnetic base material and the second magnetic base material are identical. Alternatively, the first magnetic base material and the second magnetic base material are different, in particular the first magnetic base material and the second magnetic base material differ in at least one property selected from a group consisting of a particle size, a particle shape, a particle size distribution, and a chemical composition.

Preferably, the raw magnet is magnetised, wherein a permanent magnet is obtained. The method is then in particular a method for manufacturing a permanent magnet.

According to a further development of the invention, it is provided that as the first magnetic base material and/or the second magnetic base material a material is used comprising particles of an RₓT_{y}B alloy. Preferably, as the first magnetic base material and/or the second magnetic base material, a material is used which consists of particles of an RₓT_{y}B alloy. In particular, preferably, the first magnetic base material and/or the second magnetic base material comprises particles of an NdₓFe_{y}B alloy or consists of particles of an NdₓFe_{y}B alloy.

Preferably, the first magnetic base material and/or the second magnetic base material comprises particles of an RₓT_{y}B alloy and particles of a rare-earth-rich phase. In particular, the first magnetic base material and/or the second magnetic base material preferably consists of a mixture of particles of an RₓT_{y}B alloy and particles of a rare-earth-rich phase. Preferably, the first magnetic base material and/or the second magnetic base material comprises or consists of particles of an NdₓFe_{y}B alloy and particles of a neodymium-rich phase. In particular, the first magnetic base material and/or the second magnetic base material preferably comprises or consists of a mixture of particles of an NdₓFe_{y}B alloy and particles of a neodymium-rich phase.

In the context of the present technical teachings, R represents a rare earth element, i.e. an element from the rare earth group, T represents at least one element selected from a group consisting of iron and cobalt, and B represents the element boron. In particular, the elements iron and cobalt partially or completely substitute each other in such a way that either only iron or only cobalt or any iron-cobalt mixture is present. Preferably, the rare earth element is neodymium. In a preferred embodiment, the RₓT_{y}B alloy additionally comprises another element, preferably a metal, in particular a transition metal, selected from a group consisting of aluminium, copper, zirconium, gallium, hafnium, and niobium, preferably in trace amounts.

Preferably, the first magnetic base material and/or the second magnetic base material comprises particles of an Nd₂Fe₁₄B alloy or consists of particles of an Nd₂Fe₁₄B alloy.

Preferably, the rare-earth-rich phase, in particular the neodymium-rich phase, comprises at least one rare-earth element, in particular neodymium, or a chemical compound of this rare-earth element, in particular of neodymium. In addition, the rare-earth-rich phase, in particular the neodymium-rich phase, preferably contains at least one further element of the RₓT_{y}B alloy, in particular the NdₓFe_{y}B alloy. Alternatively or additionally, the at least one rare earth element, in particular neodymium, is present in a hydrogenated form. Preferably, the neodymium-rich phase comprises or consists of NdH₂ and/or NdH_{2,7}. Alternatively, in a preferred embodiment, it is possible that the rare-earth-rich phase, in particular the neodymium-rich phase, consists of at least one rare-earth element, in particular of neodymium, or of a chemical compound of this rare-earth element, in particular of neodymium.

Alternatively, the at least one rare earth element, in particular neodymium, is preferably additionally added to the magnetic base material in a hydrogenated form, in particular NdH₂ and/or NdH_{2,7}.

The rare-earth-rich phase preferably forms a phase in the microstructure of the raw magnet which is located at grain boundaries of the microstructure. In particular, the rare-earth-rich phase is enriched at the grain boundaries of the microstructure. In particular, the rare-earth-rich phase is inhomogeneously distributed in the microstructure.

According to a further development of the invention, it is provided that as the first magnetic base material and/or as the second magnetic base material a material is used which comprises at least one compound selected from a group consisting of an aluminium-nickel-cobalt alloy, a samarium-cobalt alloy, and a ferrite alloy.

Preferably, as the first magnetic base material and/or as the second magnetic base material, a material is used consisting of at least one compound selected from a group consisting of an aluminium-nickel-cobalt alloy, a samarium-cobalt alloy, and a ferrite alloy.

In an embodiment of the method, as the first magnetic base material and/or as the second magnetic base material, a samarium-cobalt alloy comprising SmCo₅, preferably consisting of SmCo₅, is used.

In a further embodiment of the method, as the first magnetic base material and/or as the second magnetic base material, a samarium-cobalt alloy comprising Sm₂Co₁₇, iron, copper and zirconium, preferably consisting of Sm₂Co₁₇, iron, copper and zirconium, is used.

In a further preferred embodiment of the method, as the first magnetic base material and/or as the second magnetic base material, a material is used comprising an iron oxide, in particular Fe₂O₃, and at least one metal oxide, in particular nickel oxide, zinc oxide, manganese oxide, cobalt oxide, copper oxide, magnesium oxide, cadmium oxide, barium oxide, or strontium oxide. Preferably, the material consists of an iron oxide, in particular Fe₂O₃, and at least one metal oxide, in particular nickel oxide, zinc oxide, manganese oxide, cobalt oxide, copper oxide, magnesium oxide, cadmium oxide, barium oxide, or strontium oxide. Particularly preferably, the material is selected from a group consisting of a manganese-zinc ferrite, a nickel-zinc ferrite, a strontium ferrite, a barium ferrite, and a cobalt ferrite.

According to a further development of the invention, a first external magnetic field is applied to the first raw form during and/or after manufacturing of the first raw form. Furthermore, a second external magnetic field is applied to the second raw form during and/or after manufacturing of the second raw form. Preferably, the first external magnetic field and the second external magnetic field are different from each other, in particular the first external magnetic field and the second external magnetic field are not identical.

In an embodiment of the method, the first raw form is manufactured in the first externally applied magnetic field. In addition, the second raw form is manufactured in the second externally applied magnetic field. In particular, the first external magnetic field is applied to the first raw form only during the manufacturing of the first raw form. In particular, the first external magnetic field is not applied to the first raw form after manufacturing of the first raw form. In addition, the second external magnetic field is in particular applied to the second raw form only during the manufacturing of the second raw form. In particular, the second external magnetic field is not applied to the second raw form after the manufacturing of the second raw form.

In a further embodiment of the method, the first external magnetic field is applied to the first raw form after the manufacturing of the first raw form. Additionally, the second external magnetic field is applied to the second raw form after the manufacturing of the second raw form. In particular, the first external magnetic field is applied to the first raw form only after manufacturing of the first raw form. In particular, the first external magnetic field is not applied to the first raw form during the manufacturing of the first raw form. In addition, the second external magnetic field is in particular applied to the second raw form only after manufacturing of the second raw form. In particular, the second external magnetic field is not applied to the second raw form during the manufacturing of the second raw form.

In a further embodiment of the method, the first raw form is manufactured in the first externally applied magnetic field. In addition, the second external magnetic field is applied to the second raw form after manufacturing of the second raw form. In particular, the first external magnetic field is applied to the first raw form only during the manufacturing of the first raw form. In particular, the first external magnetic field is not applied to the first raw form after the manufacturing of the first raw form. In addition, the second external magnetic field is in particular applied to the second raw form only after the manufacturing of the second raw form. In particular, the second external magnetic field is not applied to the second raw form during the manufacturing of the second raw form.

In a further embodiment of the method, the first external magnetic field is applied to the first raw form after the manufacturing of the first raw form. Additionally, the second raw form is manufactured in the second externally applied magnetic field. In particular, the first external magnetic field is applied to the first raw form only after manufacturing of the first raw form. In particular, the first external magnetic field is not applied to the first raw form during the manufacturing of the first raw form. In addition, the second external magnetic field is in particular applied to the second raw form only during the manufacturing of the second raw form. In particular, the second external magnetic field is not applied to the second raw form after the manufacturing of the second raw form.

According to a further development of the invention, the first magnetic base material is mixed with a first binder, wherein a first mixture of the first magnetic base material and the first binder is obtained. Further, the second magnetic base material is mixed with a second binder, wherein a second mixture of the second magnetic base material and the second binder is obtained. The first mixture is used to manufacture the first raw form and the second mixture is used to manufacture the second raw form.

Additionally, after manufacturing the third raw form, the first binder and the second binder are at least partially, preferably completely, removed from the third raw form. Alternatively, prior to manufacturing the third raw form, the first binder and/or the second binder is at least partially, preferably completely, removed from the first raw form and/or the second raw form.

In an embodiment of the method, the first mixture comprises a volume fraction of at least 45% to at most 75% of the first magnetic base material and a volume fraction of at least 25% to at most 55% of the first binder. Alternatively or additionally, the second mixture comprises a volume fraction of at least 45% to at most 75% of the second magnetic base material and a volume fraction of at least 25% to at most 45% of the second binder. Preferably, the first binder and/or second binder comprises/comprise at least one organic binder component.

Preferably, the first mixture and the second mixture are identical. Alternatively, the first mixture and the second mixture are different, in particular the first mixture and the second mixture comprise different components and/or different proportions by weight of the individual components.

Preferably, the first raw form is heated to a first softening temperature, in particular the first softening temperature of the first mixture, while the external magnetic field is applied. Alternatively or additionally, the second raw form is heated to a second softening temperature, in particular the second softening temperature of the second mixture, while the external magnetic field is applied.

In a further embodiment of the method, the first binder and the second binder are at least partially removed from the third raw form by means of a solvent or a chemical method. In addition, a remaining portion of the first binder and the second binder is optionally removed from the third raw form by means of thermal decomposition, in particular directly before sintering.

According to a further development of the invention, it is provided that a first main component of the first binder and a second main component of the second binder are identical. Advantageously, this enables substance-to-substance bonding of the first raw form and the second raw form, in particular of the first binder and the second binder, during manufacturing of the third raw form by means of joining.

In an embodiment of the method, the first binder and the second binder are identical.

According to a further development of the invention, it is provided that at least one raw form selected from the first raw form and the second raw form is manufactured by means of a method selected from a group consisting of injection molding, in particular metal powder injection molding, additive manufacturing, extrusion, cold pressing, dry pressing, and wet pressing.

In an embodiment of the method, the first raw form is manufactured by injection molding of the first mixture comprising the first magnetic base material and the first binder. Alternatively or additionally, the second raw form is manufactured by injection molding the second mixture comprising the second magnetic base material and the second binder.

In a further embodiment of the method, at least one raw form selected from the first raw form and the second raw form is manufactured by cold pressing a magnetic base material. In cold pressing, the particles are mechanically interlocked, in particular under a pressure of up to 1 GPa. In dry cold pressing, in particular no additional liquid component is added to the magnetic base material. In wet cold pressing, at least one organic solvent, preferably a volatile organic solvent, is added to the magnetic base material. The volatile organic solvent is selected from a group consisting of an alcohol, an aliphatic, an acyclic alkane, a cyclic alkane, a ketone, an alkene, an aromatic, and a mixture of volatile organic substances that can serve as solvent. The alcohol used is preferably ethanol or isopropanol. As cyclic alkane, preferably cyclohexane is used. As ketone, preferably acetone is used. The aromatic is preferably benzene, xylene and/or toluene. The mixture of volatile organic substances is preferably selected from a group consisting of petroleum, white spirit, and benzine. The organic solvent serves in particular as a binder during wet cold pressing. Furthermore, the first raw form and/or the second raw form is preferably dried before sintering.

In a further embodiment of the method, the first raw form and the second raw form are manufactured by means of the identical method.

According to a further development of the invention, it is provided that the second raw form is injected onto the first raw form by means of injection molding, in particular of the second mixture. Thereby, the third raw form is manufactured.

Preferably, at least one magnetic base material selected from a group consisting of the first magnetic base material and the second magnetic base material comprises a hard magnetic material, in particular the at least one magnetic base material consists of a hard magnetic material. In particular, the hard magnetic material is an RₓT_{y}B alloy. In addition, at least one magnetic base material selected from a group consisting of the first magnetic base material and the second magnetic base material comprises a soft magnetic or a paramagnetic material, in particular the at most one magnetic base material consists of a soft magnetic or paramagnetic material. Preferably, the first magnetic base material comprises a hard magnetic material or consists of a hard magnetic material, and the second magnetic base material comprises a soft magnetic or paramagnetic material or consists of a soft magnetic or paramagnetic material. Advantageously, a soft magnetic or paramagnetic material can be reworked in a simple manner after sintering, in particular by means of machining.

In a preferred embodiment of the method, the first raw form and the second raw form are manufactured by means of injection molding, wherein the first raw form is overmolded with the second mixture at least in some areas. For manufacturing the first raw form, the first mixture is injected into a first cavity of a mold. After the first raw form has cooled and/or solidified, the first raw form is placed in a second cavity of the mold and is overmolded with the second mixture, wherein the second raw form, which at least partially surrounds, preferably encloses, the first raw form, is manufactured. The first raw form and the second raw form together form the third raw form. As the second mixture solidifies, the volume of the second raw form reduces. Therefore, during solidification, the second raw form shrinks onto the first raw form, thereby obtaining a frictional connection of the first raw form and the second raw form. Additionally, depending on the geometry of the first raw form and the second raw form, a form bonding of the first raw form and the second raw form is obtained. Advantageously, this method can be carried out for a plurality of raw forms.

According to a further development of the invention, it is provided that the third raw form is manufactured by means of a method selected from a group consisting of substance-to-substance bonding, in particular gluing, form bonding, frictional bonding and loose bonding.

In an embodiment of the method, the third raw form is manufactured by substance-to-substance bonding. Preferably, the first binder and the second binder comprise at least one identical binder component. Preferably, the at least one identical binder component is a thermoplastic. Further, the at least one identical binder component is the first main component of the first binder and the second main component of the second binder. Particularly preferably, at least one magnetic base material selected from a group consisting of the first magnetic base material and the second magnetic base material is a hard magnetic material.

In a first embodiment of substance-to-substance bonding, a first connection surface of the first raw form and a second connection surface of the second raw form are heated to a temperature of at least 35° C. to at most 230° C., preferably from at least 70° C. to at most 200° C., in particular by means of a hot plate or a laser, wherein the first connection surface and the second connection surface are melted. Once the first connection surface and the second connection surface are melted, the first connection surface and the second connection surface are pressed together with a pressure of at least 0.001 MPa to at most 10 MPa until the melted connection surfaces have solidified again, wherein the first raw form and the second raw form are substance-to-substance bonded together to form the third raw form.

In a second embodiment of substance-to-substance bonding, the first connection surface and the second connection surface are substance-to-substance bonded together by friction welding, wherein the third raw form is manufactured.

In a third embodiment of substance-to-substance bonding, the third raw form is manufactured by gluing. Particularly preferably, the first raw form and the second raw form are joined by means of a physically and/or a chemically curing adhesive.

In an embodiment of gluing, a hot melt adhesive which physically cures is used. Preferably, at least one binder is melted and used as an adhesive to join the first raw form and the second raw form together. Preferably, the hot melt adhesive comprises at least one magnetic base material, in particular in powdered form.

In a further embodiment of gluing, an adhesive comprising at least one polymer dissolved in a solvent is used to join the first raw form and the second raw form together. In particular, the solvent in the adhesive is evaporated, whereby an adhesive effect of the adhesive occurs.

In another embodiment of the gluing, an adhesive selected from a group consisting of a cyanoacrylate, an epoxy adhesive, and a phenolic resin is used to join the first raw form and the second raw form together.

In a further embodiment of the method, the third raw form is manufactured by form bonding. Preferably, the first raw form and the second raw form can be form bonded together via their respective geometries, in particular via a tongue and groove geometry, a screw thread geometry or a pin hole geometry. Preferably, at least one magnetic base material selected from a group consisting of the first magnetic base material and the second magnetic base material is a hard magnetic material.

In an embodiment of form bonding, a geometry enabling form bonding is configured during manufacturing of the first raw form and the second raw form.

In a further embodiment of form bonding, the geometry enabling form bonding is configured after manufacturing of the first raw form and the second raw form, in particular by means of machining.

In a further embodiment of the form bonding, the geometry enabling the form bonding is configured during the manufacturing of the first raw form and after the manufacturing of the second raw form, in particular by means of machining.

In a further embodiment of the method, the third raw form is manufactured by means of frictional bonding, in particular by means of a thread or an interference fit. Preferably, at least one magnetic base material selected from a group consisting of the first magnetic base material and the second magnetic base material is a hard magnetic material.

In a further embodiment of the method, the third raw form is manufactured by loose bonding of the first raw form and the second raw form. Advantageously, loose bonding of the first raw form and the second raw form after sintering produces a frictional and/or substance-to-substance bonding for the obtained raw magnet. Preferably, at least one magnetic base material selected from a group consisting of the first magnetic base material and the second magnetic base material is a hard magnetic material.

In an embodiment of loose bonding, the first raw form comprises a recess in which the second raw form is arranged. Preferably, the recess comprises a larger dimension than the second raw form. In particular, the first raw form comprises a first volume shrinkage of at least 15% to at most 20% during sintering. In addition, the second raw form exhibits a second volume shrinkage of at least 15% to at most 20% during sintering. Additionally, in particular the second volume shrinkage is lower than the first volume shrinkage. Advantageously, the second raw form is frictionally clamped in the recess of the first raw form during sintering due to the second volume shrinkage, which is lower than the first volume shrinkage of the first raw form. In addition, a first connection surface of the first raw form, which corresponds to the surface of the recess, and the second raw form, which is arranged in the recess, are substance-to-substance bonded to one another during sintering.

In particular, when the first raw form is manufactured from the first mixture and the second raw form is manufactured from the second mixture, the first volume shrinkage and the second volume shrinkage different from the first volume shrinkage are achieved by a first portion of the first magnetic base material in the first mixture being different from a second portion of the second magnetic base material in the second mixture.

Alternatively or additionally, when the first raw form is manufactured from the first magnetic base material and the second raw form is manufactured from the second magnetic base material, the first volume shrinkage and the second volume shrinkage different from the first volume shrinkage are achieved by differentiating a first raw form density obtained in particular in the dry pressing with a first pressure from a second raw form density obtained in particular in the dry pressing with a second pressure different from the first pressure.

In a further embodiment of loose bonding, the first raw form and the second raw form are loosely layered to produce the third raw form, wherein substance-to-substance bonding of the first raw form and the second raw form is obtained during sintering. Particularly preferably, a metal foil, in particular a stainless steel foil, is layered, in particular loosely layered, between the first raw form and the second raw form before sintering. Alternatively or additionally, a ceramic foil is layered, in particular loosely layered, between the first raw form and the second raw form before sintering. Alternatively or additionally, a plurality of first raw forms and/or a plurality of second raw forms are loosely layered to manufacture the third raw form.

According to a further development of the invention, it is provided that the first binder and the second binder comprise at least one material selected from a group consisting of polyoxymethylene, polypropylene, paraffin wax, polyethylene and polyamide. Advantageously, polyoxymethylene, polypropylene, paraffin wax, polyethylene and polyamide are thermoplastics and are therefore suitable for the configuration of a substance-to-substance bonding of the first raw form and the second raw form. Furthermore, the at least one material selected from a group consisting of polyoxymethylene, polypropylene, paraffin wax, polyethylene and polyamide facilitates an alignment of the particles of the first magnetic base material and the second magnetic base material.

According to a further development of the invention, it is provided that a separating layer is arranged, in particular inserted, between the first connection surface of the first raw form and the second connection surface of the second raw form. Advantageously, a substance-to-substance bonding of the first raw form and the second raw form is prevented by means of the separating layer between the first raw form and the second raw form. Preferably, due to the separating layer, in particular during loose bonding, only a frictional connection of the first raw form and the second raw form is configured.

Advantageously, by means of the separating layer it is possible to separate the first raw form and the second raw form from each other with respect to at least one chemical and/or physical property of the raw forms and in particular of the permanent magnet. In particular, the first connection surface and the second connection surface face each other and are separated from each other or separated with respect to at least one property by the separating layer.

In a further embodiment of the method, the separating layer is configured as at least one closed, that is in particular continuous, separating layer. Alternatively, the separating layer is configured as a separating layer that is not closed or is open in regions, in particular as a plurality of separating layer fragments present in regions. Alternatively, the separating layer is configured in the form of particles on at least one connection surface selected from the first connection surface and the second connection surface.

According to a further development of the invention, it is provided that a material comprising at least one compound selected from a group consisting of aluminium oxide, zirconium oxide, yttrium oxide, and at least one rare-earth-oxide is used as the separating layer.

Preferably, a material consisting of at least one compound selected from a group consisting of aluminium oxide, zirconium oxide, yttrium oxide, and at least one rare-earth-oxide is used as a separating layer.

According to a further development of the invention, it is provided that the third raw form is at least partially, preferably completely, debinded. Preferably, during the debinding, the at least one binder component is at least partially, preferably completely, removed from the third raw form.

Preferably, the third raw form is partially debinded by means of a solvent. Subsequently, preferably a thermal debinding is carried out, in particular the thermal debinding is carried out before sintering.

Alternatively, the third raw form is completely debinded by means of a solvent, in particular the third raw form is debinded before sintering.

According to a further development of the invention, it is provided that the third raw form is sintered in an atmosphere comprising at least one process gas selected from a group consisting of argon and helium. Particularly preferably, the atmosphere in which the third raw form is sintered consists of at least one process gas selected from a group consisting of argon and helium. Alternatively, the third raw form is preferably sintered in a vacuum.

According to a further development of the invention, it is provided that a Halbach-Array is manufactured as the raw magnet. In this case, the first raw form is manufactured by means of injection molding in the externally applied magnetic field comprising a magnetic field orientation. The first raw form is then rotated in such a way that a particle orientation in the first raw form is orthogonal to the magnetic field orientation. Then, the second raw form is injection molded onto the rotated first raw form by means of injection molding in the externally applied magnetic field. Advantageously, this method makes it possible to easily and efficiently manufacture a Halbach-Array, in particular in a magnetic shape adapted to the application.

Preferably, the first raw form is not turned until the first raw form has solidified. Alternatively or additionally, the external magnetic field is not applied to the first raw form when the first raw form is rotated.

Preferably, the second raw form is not injected onto the first raw form until the first raw form has solidified.

In an embodiment, the method is carried out several times in succession, in particular four times in succession, to obtain a Halbach-Array comprising a plurality of raw forms, in particular five raw forms.

The invention also includes a raw magnet, in particular a permanent magnet obtained after magnetisation of the raw magnet, in particular a Halbach-Array, which is manufactured by means of a method according to the invention or by means of a method according to one or more of the embodiments described above.

The invention also includes a raw magnet, in particular a permanent magnet obtained after magnetisation of the raw magnet, which comprises at least one separating layer arranged in an interior of the permanent magnet, preferably as an electrical resistance layer or as an electrically insulating layer. In particular, the permanent magnet is manufactured in a method according to the invention or in a method according to one or more of the embodiments described above.

In an embodiment, the permanent magnet comprises at least five separating layers, preferably at least ten separating layers, preferably at least 15 separating layers, particularly preferably 20 separating layers, in the interior of the permanent magnet, wherein one separating layer is arranged between each two layers of the permanent magnet formed from a respective raw form.

The invention further includes a use of such a raw magnet, in particular such a permanent magnet, in a device selected from a group consisting of an electric motor, a loudspeaker, a microphone, a generator, a hard disk drive, and a sensor.

The invention also includes a device selected from a group consisting of an electric motor, a loudspeaker, a microphone, a generator, a hard disk drive, and a sensor, wherein the device comprises a permanent magnet provided by a method according to the invention or a method according to one or more of the embodiments described above.

The invention is explained in more detail below with reference to the drawing. Thereby show:

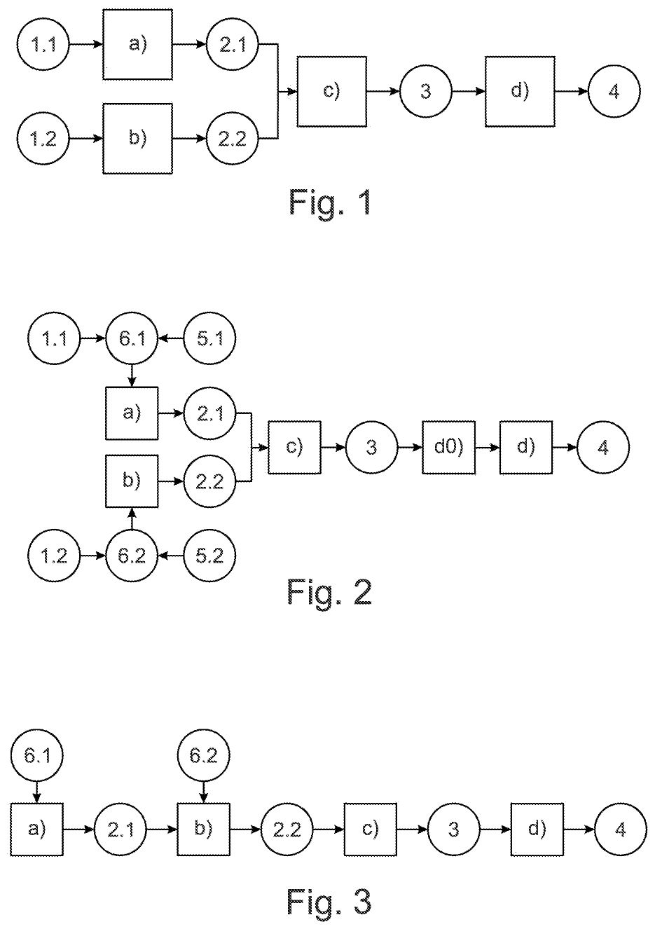

FIG. 1 a flow diagram of a first embodiment of a method for manufacturing a raw magnet,

FIG. 2 a flow diagram of a second embodiment of the method for manufacturing the raw magnet,

FIG. 3 a flow diagram of a third embodiment of the method for manufacturing the raw magnet,

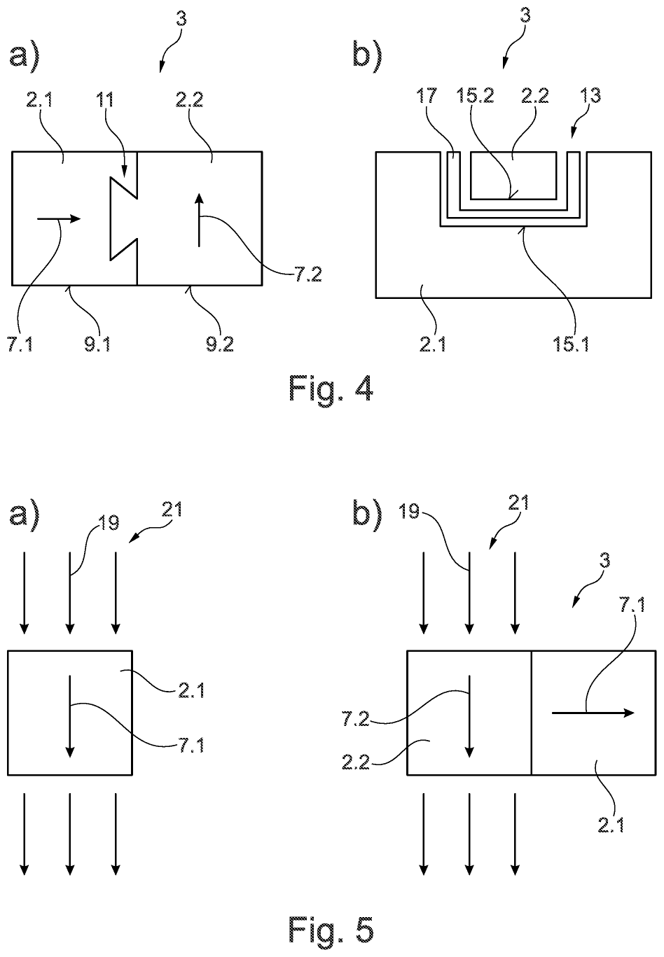

FIG. 4 a schematic representation of a first and second joining method for manufacturing a third raw form, and

FIG. 5 a schematic representation of a third joining process for manufacturing the third raw form as a Halbach-Array.

FIG. 1 shows a flow diagram of a first embodiment of a method for manufacturing a raw magnet 4.

In a step a), a first raw form 2.1 is manufactured from a first magnetic base material 1.1.

In a step b), a second raw form 2.2 is manufactured from a second magnetic base material 1.2.

Particularly preferably, as the first magnetic base material 1.1 and/or as the second magnetic base material 1.2, a material is used which is made from particles of an RₓT_{y}B alloy and preferably particles of a rare-earth-rich phase. Alternatively, as the first magnetic base material 1.1 and/or as the second magnetic base material 1.2, a material selected from a group consisting of an aluminium-nickel-cobalt alloy, a samarium-cobalt alloy, and a ferrite alloy is used.

An external magnetic field 21 is applied to at least one raw form 2 selected from a group consisting of the first raw form 2.1 and the second raw form 2.2 during and/or after manufacturing of the raw form 2 according to step a) or b).

Preferably, the first raw form 2.1 is manufactured in the externally applied magnetic field 21. Alternatively or additionally, the external magnetic field 21 is applied to the first raw form 2.1 after manufacturing of the first raw form 2.1. Alternatively or additionally, the second raw form 2.2 is manufactured in the externally applied magnetic field 21. Alternatively or additionally, the external magnetic field 21 is applied to the second raw form 2.2 after manufacturing of the second raw form 2.2.

Particularly preferably, a first external magnetic field is applied to the first raw form 2.1 during and/or after the manufacturing of the first raw form 2.1. In addition, a second external magnetic field is applied to the second raw form 2.2 during and/or after the manufacturing of the second raw form 2.2.

Preferably, the first raw form 2.1 is manufactured in the first externally applied magnetic field and the second raw form 2.2 is manufactured in the second externally applied magnetic field. Alternatively or additionally, the first external magnetic field is applied to the first raw form 2.1 after manufacturing of the first raw form 2.1 and the second external magnetic field is applied to the second raw form 2.2 after manufacturing of the second raw form 2.2.

Preferably, the first raw form 2.1 is manufactured in the first externally applied magnetic field and the second external magnetic field is applied to the second raw form 2.2 after manufacturing the second raw form 2.2. Alternatively or additionally, the first external magnetic field is applied to the first raw form 2.1 after manufacturing of the first raw form 2.1 and the second raw form 2.2 is manufactured in the second externally applied magnetic field.

Preferably, the first external magnetic field and the second external magnetic field differ from each other, in particular the first external magnetic field and the second external magnetic field are not identical. Preferably, the first magnetic field is used to produce a first particle orientation 7.1 of the first raw form 2.1 and the second magnetic field is used to produce a second particle orientation 7.2 of the second raw form 2.2. Alternatively to using the first magnetic field and the second magnetic field, in particular to generate two different particle orientations 7, an orientation of the first raw form 2.1 and/or the second raw form 2.2 is varied in the external magnetic field.

Preferably, at least one raw form 2 selected from the first raw form 2.1 and the second raw form 2.2 is manufactured, in particular in the step a) and/or in the step b), by means of a method selected from a group consisting of injection molding, additive manufacturing, extrusion, cold pressing, dry pressing, and wet pressing.

In a step c), the first raw form 2.1 and the second raw form 2.2 are joined together by means of joining, wherein a third raw form 3 is manufactured.

The third raw form 3 is preferably manufactured by means of a method selected from a group consisting of substance-to-substance bonding, in particular gluing, form bonding, frictional bonding, and loose bonding.

In a step d), the third raw form 3 is sintered, wherein the raw magnet 4 is obtained. Preferably, the third raw form 3 is sintered in an atmosphere comprising at least one process gas selected from a group consisting of argon and helium. Particularly preferably, the atmosphere consists of at least one process gas selected from a group consisting of argon and helium. Alternatively, the third raw form 3 is sintered in a vacuum.

FIG. 2 shows a flow diagram of a second embodiment of a method for manufacturing the raw magnet 4.

Identical and functionally identical elements are provided with the same reference signs in all figures, so that reference is made to the preceding description in each case.

Furthermore, identical or functionally identical process steps are provided with identical letters, so that reference is made to the previous description in each case.

The first magnetic base material 1.1 is mixed with a first binder 5.1, wherein a first mixture 6.1 is obtained from the first magnetic base material 1.1 and the first binder 5.1. In step a), the first mixture 6.1 is used to manufacture the first raw form 2.1.

The second magnetic base material 1.2 is mixed with a second binder 5.2, wherein a second mixture 6.2 is obtained from the second magnetic base material 1.2 and the second binder 5.2. In step b), the second mixture 6.2 is used to manufacture the second raw form 2.2.

In step c) the first raw form 2.1 and the second raw form 2.2 are joined together by means of joining, wherein the third raw form 3 is produced.

In a step d0) the first binder 5.1 and the second binder 5.2 are at least partially, preferably completely, removed from the third raw form 3 before sintering and after manufacturing the third raw form 3.

Preferably, a first main component of the first binder 5.1 and a second main component of the second binder 5.2 are identical. Alternatively or additionally, the first binder 5.1 and the second binder 5.2 comprise at least one substance selected from a group consisting of polyoxymethylene, polypropylene, paraffin wax, polyethylene and polyamide.

FIG. 3 shows a flow diagram of a third embodiment of a method for manufacturing the raw magnet 4.

The first raw form 2.1 and the second raw form 2.2 are preferably not manufactured separately from each other. In step a), the first raw form 2.1 is manufactured from the first mixture 6.1 by means of injection molding. In step b), the first raw form 2.1 is overmolded with the second mixture 6.2 by means of injection molding. Alternatively, in step b) the second mixture 6.2 is injection molded onto the first raw form 2.1. In step b), the second raw form 2.2 is thus manufactured, wherein in a preferred embodiment the second mixture 6.2 is form bonded to the first raw form 2.1. In step c), the second raw form 2.2 preferably solidifies and thus shrinks onto the first raw form 2.1 and/or joins with the first raw form 2.1, wherein the third raw form 3 is manufactured. In this embodiment, the joining step thus comprises the solidification of the second raw form 2.2.

FIG. 4 a) shows a schematic representation of a first joining process for manufacturing the third raw form 3.

The first raw form 2.1 and the second raw form 2.2 are joined together by form bonding to form the third raw form 3.

The first raw form 2.1 is manufactured in a first externally applied magnetic field. Alternatively or additionally, the first external magnetic field is applied to the first raw form 2.1 after manufacturing of the first raw form 2.1. Therefore, the first raw form 2.1 comprises the first particle orientation 7.1.

The second raw form 2.2 is manufactured in the first externally applied magnetic field. Alternatively or additionally, the first external magnetic field is applied to the second raw form 2.2 after manufacturing of the second raw form 2.2. Therefore, the second raw form 2.2 comprises the second particle orientation 7.2 different from the first particle orientation 7.1.

Alternatively, the second raw form 2.2 is manufactured in a second externally applied magnetic field. Alternatively or additionally, the second external magnetic field is applied to the second raw form 2.2 after manufacturing of the second raw form 2.2. Therefore, the second raw form 2.2 comprises the second particle orientation 7.2.

In particular, the first external magnetic field and the second external magnetic field differ from each other, in particular the first external magnetic field and the second external magnetic field are not identical. Therefore, the first particle orientation 7.1 and the second particle orientation 7.2 differ from each other, in particular the first particle orientation 7.1 and the second particle orientation 7.2 are not identical.

Preferably, the first geometry 9.1 of the first raw form 2.1 and the second geometry 9.2 of the second raw form 2.2 are matched to each other in such a way that the first raw form 2.1 and the second raw form 2.2 can be joined together by form bonding to form the third raw form 3. Alternatively, the first geometry 9.1 and/or the second geometry 9.2 are machined in such a way that the first raw form 2.1 and the second raw form 2.2 can be joined together by form bonding to form the third raw form 3.

The first geometry 9.1 and the second geometry 9.2 comprising a tongue and groove joint 11.

FIG. 4 b) shows a schematic representation of a second joining method for manufacturing the third raw form 3.

The first raw form 2.1 and the second raw form 2.2 are joined together by loose joining to form the third raw form 3.

Preferably, the first raw form 2.1 comprises a recess 13 into which the second raw form 2.2 is inserted. Particularly preferably, the recess 13 of the first raw form 2.1 is larger than the second raw form 2.2.

During sintering of the third raw form 3, the first raw form 2.1 and the second raw form 2.2 shrink. Since during sintering a first volume shrinkage of the first raw form 2.1 is greater than a second volume shrinkage of the second raw form 2.2, the first raw form 2.1 shrinks onto the second raw form 2.2 and a frictional bond is configured between the first raw form 2.1 and the second raw form 2.2. Advantageously, a substance-to-substance bonding is further formed between a first connection surface 15.1 of the first raw form 2.1 and a second connection surface 15.2 of the second raw form 2.2 during sintering.

Alternatively, a separating layer 17 is inserted between the first connection surface 15.1 of the first raw form 2.1 and the second connection surface 15.2 of the second raw form 2.2, whereby a substance-to-substance bonding of the first raw form 2.1 and the second raw form 2.2, in particular of the first connection surface 15.1 of the first raw form 2.1 and the second connection surface 15.2 of the second raw form 2.2, is prevented.

Preferably, the separating layer 17 is a material comprising at least one compound selected from a group consisting of aluminium oxide, zirconium oxide, yttrium oxide, and at least one rare-earth-oxide. Particularly preferably, the separating layer 17 consists of at least one compound selected from a group consisting of aluminium oxide, zirconium oxide, yttrium oxide, and at least one rare-earth-oxide.

FIG. 5 shows a schematic representation of a third joining process for manufacturing the third raw form 3 as a Halbach-Array.

In FIG. 5 a) the first raw form 2.1 is manufactured in the externally applied magnetic field 21. Alternatively, the external magnetic field 21 is applied to the first raw form 2.1 after manufacturing the first raw form 2.1, while the first raw form 2.1 is preferably heated to a softening temperature. Thereby, the particles of the first magnetic base material 1.1 align according to a magnetic field orientation 19 of the external magnetic field 21, and the first particle orientation 7.1 is generated in the first raw form 2.1. Subsequently, the first raw form 2.1 is rotated such that the first particle orientation 7.1 in the first raw form 2.1 is orthogonal to the magnetic field orientation 19.

Preferably, the first raw form 2.1 is manufactured from the first mixture 6.1 by means of injection molding.

In FIG. 5 b), the second raw form 2.2 is injection molded onto the turned first raw form 2.1 by means of injection molding of the second mixture 6.2 in the externally applied magnetic field 21, wherein the third raw form 3 is produced. In the process, the particles of the second magnetic base material 1.2 align themselves in accordance with the external magnetic field 21, and the second particle orientation 7.2 is produced in the second raw form 2.2.

A raw magnet 4 in the form of a Halbach-Array is obtained from the third raw form 3 by means of sintering.

1. A method for manufacturing a raw magnet the method comprising:
manufacturing a first raw form from a first magnetic base material;
manufacturing a second raw form from a second magnetic base material;
applying an external magnetic field to at least one raw form selected from a group consisting of the first raw form and the second raw form during and/or after manufacturing of the raw form,
wherein:
a third raw form is manufactured from the first raw form and the second raw form by joining them together, and
the third raw form is sintered, wherein the raw magnet is obtained.

2. The method according to claim 1, wherein at least one of the first magnetic base material and the second magnetic base material is made of a material including particles of an RₓT_{y}B alloy and preferably particles of a rare-earth-rich phase.

3. The method according to claim 1, wherein at least one of the first magnetic base material and the second magnetic base material is a material made of particles selected from a group consisting of an aluminium-nickel-cobalt alloy, a samarium-cobalt alloy, and a ferrite alloy.

4. The method according to claim 1, wherein a first external magnetic field is applied to the first raw form during and/or after manufacturing of the first raw form, wherein a second external magnetic field is applied to the second raw form during and/or after manufacturing of the second raw form.

5. The method according to claim 1, wherein
the first magnetic base material is mixed with a first binder, wherein
a first mixture of the first magnetic base material and the first binder is obtained, wherein
the first raw form is manufactured from the first mixture, wherein
the second magnetic base material is mixed with a second binder, wherein
a second mixture of the second magnetic base material and the second binder is obtained, wherein
the second raw form is manufactured from the second mixture, wherein
the first binder and the second binder are at least partially removed from the first raw form and/or the second raw form after and/or before manufacturing the third raw form and before sintering.

6. The method according to claim 1, wherein a first main component of the first binder and a second main component of the second binder are identical.

7. The method according to claim 1, wherein at least one raw form selected from the first raw form and the second raw form is manufactured by a method selected from a group consisting of injection molding, additive manufacturing, extrusion, cold pressing, dry pressing, and wet pressing.

8. The method according to claim 1, wherein the second raw form is injection molded onto the first raw form by means of injection molding, in particular of the second mixture, wherein the third raw form is manufactured.

9. The method according to claim 1, wherein the third raw form is manufactured by means of a method selected from a group consisting of substance-to-substance bonding, in particular gluing, form bonding, frictional bonding and loose bonding.

10. The method according to claim 1, wherein the first binder and the second binder comprise at least one compound selected from a group consisting of polyoxymethylene, polypropylene, paraffin wax, polyethylene and polyamide.

11. The method according to claim 1, wherein a separating layer is arranged between a first connection surface of the first raw form and a second connection surface of the second raw form.

12. The method according to claim 1, wherein as the separating layer a material is used which is made of at least one compound selected from a group consisting of aluminium oxide, zirconium oxide, yttrium oxide, and at least one rare-earth-oxide.

13. The method according to claim 1, wherein the third raw form is sintered in a vacuum or in an atmosphere comprising at least one process gas selected from a group consisting of argon and helium.

14. The method according to claim 1, wherein a Halbach-Array is manufactured as the raw magnet, wherein
the first raw form is manufactured by injection molding in the externally applied magnetic field comprising a magnetic field orientation, wherein
the first raw form is subsequently rotated such that a particle orientation in the first raw form is orthogonal to the magnetic field orientation, wherein
the second raw form is injection molded onto the rotated first raw form in the externally applied magnetic field by means of injection molding.

15. The method according to claim 1, wherein at least one of the first magnetic base material and the second magnetic base material is made of a material including particles of an RₓT_{y}B alloy, the particles of a rare-earth-rich phase.

16. The method according to claim 8, wherein the second raw form is injection molded onto the first raw form by injection molding of the second mixture.
